(19) United States
(12) Patent Application Publication
(10) Pub. No.: US 2026/0089052 A1
(43) Pub. Date: Mar. 26, 2026

(54) AUTOMATED MANAGEMENT OF A CONTAINERIZED ENVIRONMENT

(71) Applicant: DISH Wireless L.L.C., Englewood, CO (US)

(72) Inventor: Collin Hart Marsden, Lone Tree, CO (US)

(21) Appl. No.: 18/896,689

(22) Filed: Sep. 25, 2024

(51) Int. Cl. H04L 41/0654; H04L 43/02; H04L 43/20

(52) U.S. Cl. CPC H04L 41/0654; H04L 43/02; H04L 43/20

(57) ABSTRACT

A method is described that includes dynamically obtaining, at one or more computing devices, performance metrics and log data related to a set of clusters executing containerized network functions (CNFs) associated with a 5G open radio access network (O-RAN). The CNFs can be executed on a distributed system for orchestrating operations of containerized applications. The performance metrics and the log data can be stored at a storage device for a threshold duration. The performance metrics and log data are indicative of a present state of the 5G O-RAN. A performance issue affecting at least one of the CNFs can be identified based on the performance metrics and log data. An instruction for remedying the performance issue, responsive to identifying the performance issue, can be provided. The instruction can be for affecting the operations of at the at least one CNF to remedy the performance issue.

### TECHNICAL FIELD

This specification relates to computer-implemented methods, software, and systems for data processing and resource allocation in a containerized environment.

### BACKGROUND

In a cloud-deployed wireless network, various network functions can be implemented using a cloud computing platform. The performance of the network functions can be monitored and evaluated to provide reliable network services.

### SUMMARY

In a general aspect, a method performed by a computing device and in relation to a network environment is provided. In some implementations, the method can be executed at a computing device outside or within the network environment. The method includes dynamically obtaining, at one or more computing devices, performance metrics and log data related to a set of clusters executing containerized network functions (CNFs) associated with a 5G open radio access network (O-RAN). The CNFs can be executed on a distributed system for orchestrating operations of containerized applications. The method further includes storing the performance metrics and log data at a storage device for a threshold duration, such that the performance metrics and log data is indicative of a present state of the 5G O-RAN. The method further includes identifying, by the one or more computing devices and based on the performance metrics and log data, a performance issue affecting at least one of the CNFs. The method further includes providing an instruction for remedying the performance issue by affecting the operations of at the at least one CNF responsive to identifying the performance issue.

Implementations of the method can include one or more of the following features. The distributed system includes multiple availability zones, each availability zone including a subset of the set of clusters. The identification of the performance issue can be based on a portion of the performance metrics and log data collected for a corresponding availability zone.

In some implementations, the method further includes registering the set of clusters at a monitoring service for providing data including the performance metrics and the log data.

In some implementations, each cluster can run at least one CNF deployed on a node of the cluster, wherein each CNF encapsulates physical and virtual network functions associated with the 5G O-RAN. In some implementations, each cluster can execute a performance agent to collect performance metrics and log data related to a CNF running on each cluster. The performance metrics and the log data can be usable to determine performance of the respective cluster.

In some implementations, the method further includes storing the data in a storage device for executing offline analysis and identifying actions to be used for generating the instruction.

In some implementations, the method further includes receiving information indicative of a creation of a new account at a new set of clusters. The new set of clusters can be instantiated at the 5G O-RAN. The method can further include automatically obtaining new performance metrics and log data for the new account from a monitoring service to be stored at i) an analytics suite for temporary storage and ii) the storage device. The new account can be registered at a monitoring service so that the new set of clusters automatically provide the performance metrics and log data to the monitoring service.

In some implementations, providing the instruction can include providing a notification to at least an external responder system associated with at least one cluster of the set of clusters. Providing the notification can include displaying the notification at a display device associated with the external responder system. The notification can include a definition of an action to be executed at the 5G O-RAN. The action can be at least one of a set of lifecycle operations to be executed for applications running at one or more of the set of clusters, the set of lifecycle operations comprising at least one of restarting, updating, upgrading, rebuilding of an application running on a cluster of the set of clusters.

The present disclosure further provides a system for implementing the methods provided herein. The system includes one or more processors and a computer-readable storage medium coupled to the one or more processors, having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Various implementations of the technology described herein may provide one or more of the following advantages. The technologies described herein can enable efficient data processing for determining performance of clusters in a distributed network so that issues can be promptly identified and addressed. The metrics data can be collected centrally from clusters distributed over various accounts and multiple cloud platform infrastructures on the 5G network. Based on implementations of the present disclosure, an instantaneous view of the current state of the network can be provided. In some cases, the state of the network can be dynamically monitored and updated to provide an up-to-date view of the status that can be used for defining instructions for refinement of the running instances on nodes of the clusters. By dynamically monitoring the status of the platform and instances running on the platform, relevant measures to address issues in the execution of the services can be determined efficiently. The monitoring of the status of the platform can be used for determining refinement actions as an immediate solution but also as based on long-term considerations for improving the infrastructure and providing services fine-tuned to the resources requested by users. In some cases, the refinements can be flexibly tailored to dynamically modify demands of users of network services, so that the cloud platform can be adjusted based on current needs and requests for services.

The details of one or more implementations of the present disclosure are set forth in the accompanying drawings and the description below. Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIG. 1A is a diagram of an example of a network environment and a user-device connected to the exemplary network environment.

FIG. 1B is a diagram of an example of a virtual network environment including a cloud-native mobile network.

FIG. 2 is a diagram of an example of a virtual network environment including a cloud-native containerized mobile network.

FIG. 3 is a flowchart of an example of a process for providing instructions for remedying performance issues affecting operations of network functions in a containerized environment in accordance with monitored performance metrics.

FIG. 4 is a diagram illustrating an example of a computing environment.

### DETAILED DESCRIPTION

The technology described herein relates to monitoring performance of clusters of nodes in a containerized network environment running network functions in distributed manner. For example, a 5G open radio access network (O-RAN) can be implemented on distributed clusters of nodes in a containerized network environment, such that various network functions are executed—potentially in a distributed manner—on the clusters. In accordance with implementations of the present disclosure, performance metrics and log data related to the network functions can be obtained and evaluated to determine a state of a 5G open radio access network (O-RAN). The distributed system can include multiple availability zones (e.g., data centers distributed at various geo-locations), where each availability zone can include a subset of the clusters. In some implementations, an identification of a performance issue can be performed based on evaluating performance metrics and log data. In some cases, the issues can be associated with one or more availability zones, and more precisely, at a particular cluster of a respective availability zone. By monitoring performance of network functions running on the distributed system, performance issues associated with the 5G O-RAN can be identified and addressed automatically, for example, by providing relevant instructions to one or more network entities.

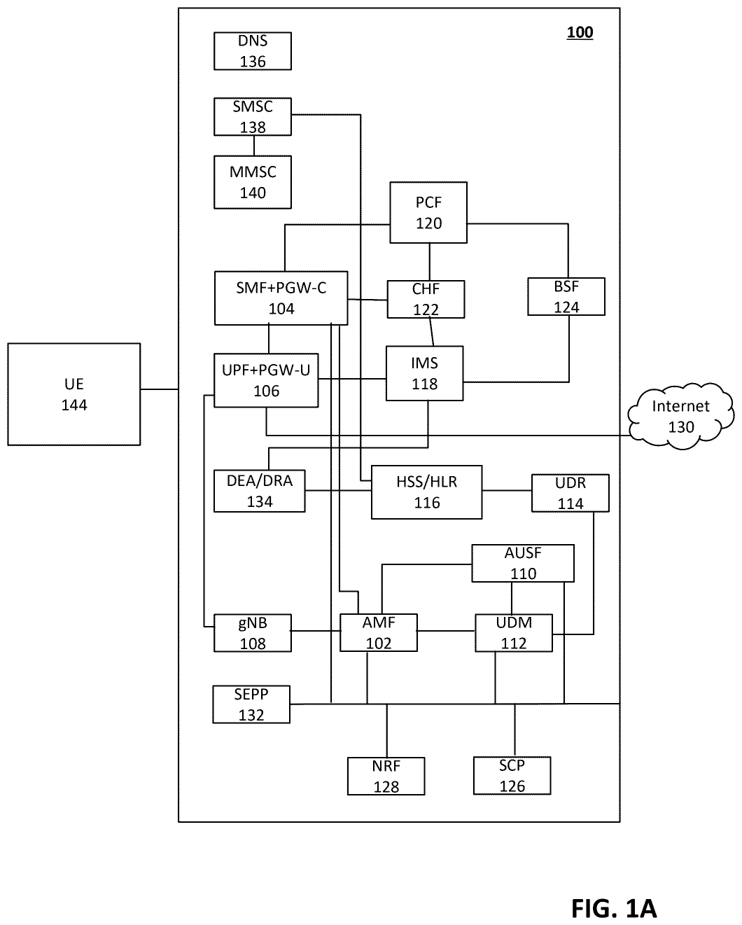

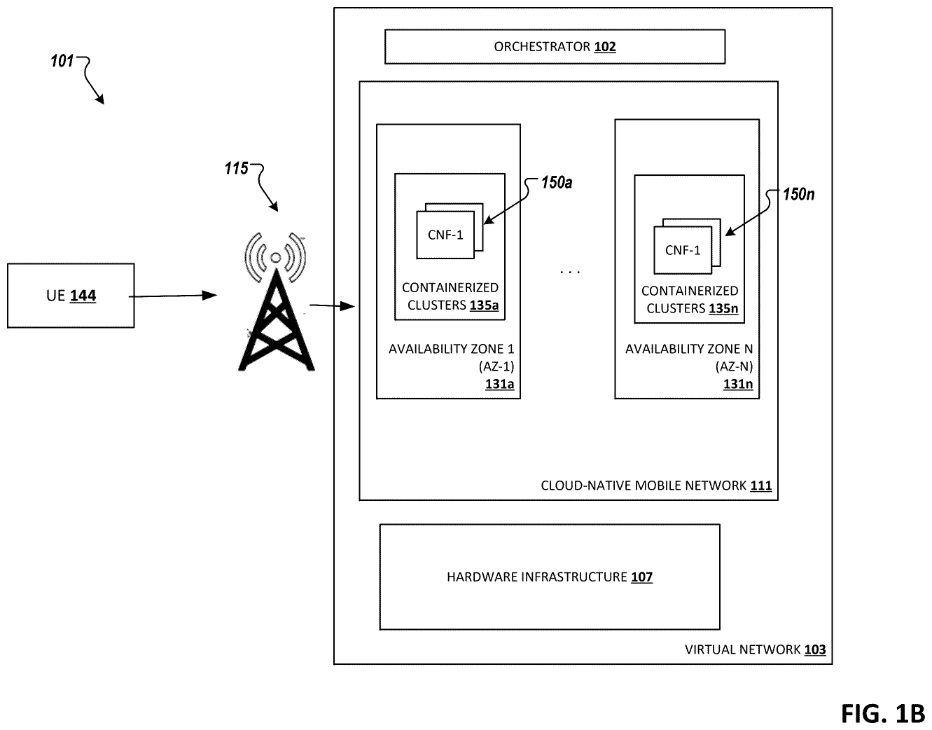

FIG. 1A depicts a diagram of an example of a network environment 100 and a user equipment (UE) device 144 connected to the network environment 100. As used herein, a network environment (sometimes referred to herein simply as an environment) refers to a set of multiple devices, modules, and functions that are configured to jointly enable wireless communication. For example, a network environment can include a 5G network that includes a set of multiple devices, radio access network (RAN)/core network functions, and application functions that are configured and integrated to jointly enable wireless communication. In some implementations, the network may be a hybrid cellular network that includes a physical RAN and relies on a cloud computing platform to host various network functions (NF), such as core network functions.

In some implementations, the environment 100, can be a portion of a 5G New Radio (“5G-NR” or simply “5G”) cellular network environment. Standards for cellular network architectures have been described, for example, in 3GPP TS 23.501 (for 5G networks) and 3GPP TS 23.401 (for 4G long-term evolution “LTE” networks) (the entireties of which are hereby incorporated by reference). While FIG. 1 shows an example of an architecture for a network environment, other architectures are within the scope of the technology described herein.

In some implementations, network environment 100 includes a packet core network, which includes an access management function (AMF) 102, a session management function and packet data network gateway-control module (SMF+PGW-C) 104, a user plane function and packet data network gateway-user plane module (UPF+PGW-U) 106, and a policy control function (PCF) 120. The AMF 102 receives all connection and session related information from one or more user equipment (UE) devices 144, and manages connection and mobility management tasks. The AMF 102 forwards all messages related to session management to the SMF+PGW-C module 104. The SMF+PGW-C module 104 and UPF+PGW-U module 106 jointly manage sessions and are configured using Control and User Plane Separation (CUPS). The PCF 120 communicates with the SMF+PGW-C module 104, governing control plane functions via defined policy rules. The UPF+PGW-U module 106 can provide access to the Internet 130 for data applications and the IP Multimedia Subsystem (IMS) core module 118 for voice applications. The IMS core module 118 is a separate application core network from the packet core network and supports voice services, messaging, voice calls, etc.

The environment 100 can further include a charging function (CHF) 122 and a binding support function (BSF) 124. The CHF 122 supports online and offline charging features and completes billing functions. The BSF 124 tracks sessions that are located anywhere in the environment 100, but share common criteria, such as subscriber identifiers. The BSF 124 communicates with the PCF 120 and binds application-function requests to specific PCF instances, enabling policy scaling of the environment 100.

The environment 100 also includes a gNB 108 (i.e., a 5G base station), which handles run-side aspects of the network environment 100 and communicates, either directly or indirectly, with the packet core network elements such as AMF 102, SMF+PGW-C module 104, and UPF+PGW-U module 106.

The environment 100 further includes network elements to manage user or subscriber information. For example, the environment 100 includes an authentication service function (AUSF) 110 for user authentication and a unified data management (UDM) module 112. The user database is stored in a unified data repository (UDR) 114. The UDM 112 communicates with the AMF 102, AUSF 110, and the UDR 114 to provide centralized control of network user data. For interworking with 2G, 3G, and 4G network elements, the environment 100 also includes a Home Subscriber System and Home Location Register (HSS/HLR) module 116, which stores subscriber information, location, SIM details, and authentication keys.

The environment 100 further includes a service communication proxy (SCP) 126 and a network repository function (NRF) 128. In accordance with current 5G standards, network functions are based on HTTP version 2, and use the SCP 126 and NRF 128 to communicate. The NRF 128 is used to discover network functions in the environment 100, and the SCP 126 is used to provide a single point of entry for a cluster of discovered network functions, serving as a central control point in the signaling network core.

The environment 100 further includes a security edge protection proxy (SEPP) 132, a diameter edge agent, a diameter routing agent (DEA/DRA) module 134, and a domain name system (DNS) 136. The SEPP 132 is a security proxy through which all signaling traffic across operator networks is expected to transit. The DEA/DRA module 134 manages traffic and congestion of messages routed across the environment 100, routing signaling traffic and performing load balancing, relay, proxy, and redirect functions within a carrier or interworking with other carriers. The DNS 136 is a naming database in which internet domain names are located and translated into internet protocol (IP) addresses.

The environment 100 further includes a short message service center (SMSC) 138 and a multimedia message service center (MMSC) 131n configured to receive, store, route, and forward SMS messages and MMS messages, respectively.

The network environment 100 can be configured to interact with external systems. In some implementations, the external systems can include another network such as a 4G or 5G roaming partner network. For example, the environment 100 can interact with a roaming partner network using an IP Packet eXchange (IPX) telecommunications interconnection model provided between the two network environments. In other examples, the environment 100 can interact directly with the roaming partner network environment without an IPX provider in between the two networks.

In some implementations, the external systems can include a message aggregator configured to aggregate messages and route a portion of the aggregated messages to the environment 100. For example, the aggregated messages can be SMS or MMS messages.

The UE 144 can interact with the network environment 100 indirectly through the external systems or directly with the network environment 100 (e.g., via the gNB 108). In some cases, the UE 144 can be a subscriber to the network environment 100 (e.g., a subscriber to a service provider of the cellular network). In other cases, the UE 144 can be a non-subscriber roaming on the network environment 100.

FIG. 1B is a diagram of an example of a virtual network environment 101 including a cloud-native mobile network 111. The virtual network environment 101 can include a virtual network 103 that includes hardware and software resources to provide mobile network services to user devices, such as the UE 144. The virtual network environment can include user equipment 144, an antenna structure 115, and a virtual system 103 to host different services and applications that implement the functionality provided by various components of the virtual system 103. In some implementations, the virtual network environment 101 can include a virtualized mobile network implemented on a cloud platform such as an Amazon Web Services (AWS) platform.

UE 144 can represent various types of end-user devices, such as mobile phones, smartphones, cellular devices, etc. The antenna structure 115 can be any structure to which an antenna can be attached. The antenna structure 115 can be dedicated cellular towers, a building, a tower, or other structures that can allow antennas to be mounted and network resources to be provided to a covered geographical area.

In a virtualized arrangement, specialized software running on hardware may be used to perform functions such as the AMF 102, the SMF+PGW-C 104, the UPF+PGW-U 106, the PCF 120, the CHF 122, the BSF 124, or the NRF 128 as described in relation to FIG. 1A. The functionality of such functions can be distributed to physical server systems that may or may not be co-located.

In some implementations, some functions in the virtual system 103 can be executed at a same data center, while other functions may be executed at separate data centers or on separate cloud platforms. The cloud-native mobile network 111 can be executed over a cloud platform that can be a third-party cloud-based computing platform or a cloud platform operated by the same entity as operating the virtual system 103. The cloud-native mobile network 111 can provide hardware resources to cloud-based applications (e.g., network components).

The cloud-native mobile network 111 can be used to create, manage, and maintain 5G core components (units or subunits) needed for providing a mobile network that is functional and operational. In some implementations, the cloud-native mobile network may be configurable to add more instances of applications and services if network traffic increases without adding additional hardware. The instances of the 5G core components can be created and managed in a containerized setup, for example, by using Kubernetes, Docker, or another container orchestration platform.

The cloud-native mobile network 111 can be managed by an orchestrator 102. The orchestrator 102 can represent a logical component that is executed at the underlying hardware 107 and is implemented to perform monitoring and management of the cloud-native mobile network 110. The orchestrator 102 can monitor and manage the software deployment process and provide software management tools and techniques to provide services through executed containerized applications that meet predefined service-level criteria. In some implementations, the orchestrator 102 can be configured to monitor network traffic associated with functions provided by the cloud-native mobile network 110. The orchestrator 102 can allow for the instantiation of applications in availability zones on the cloud-native mobile network 110.

For example, the orchestrator 102 can instruct to instantiate a new cloud component (e.g., an application or service), at one or more of the multiple zones referred to as “Availability zone 1” 131a to “Availability zone N” 131n. In some cases, the availability zones (“Availability zone 1” 31a to “Availability zone N” 131n) can be distributed over one or more data centers at one or multiple locations to provide service coverage at a designated area. Cloud-based components can be instantiated by loading respective source code for a component, creating clusters, and loading containers to provide a respective function.

In some implementations, an availability zone at the cloud-native mobile network can support the execution of applications over clusters (e.g., Kubernetes clusters) that allow containers to run across multiple machines (e.g., virtual machines, physical machines, cloud based, server based, etc.). A cluster can be considered as a set of nodes (e.g., virtual machines) that run containerized applications. When an application is containerized, the application is packaged with entities (e.g., libraries, other packages, source code, configuration files, etc.) on which the application depends and related services in a container so that the application is lightweight and flexible compared to virtual machines. Containerized applications can be easier to develop, instantiate, and manage compared to other cloud computing techniques. Containerization provides tools and techniques to pack small units or components (e.g., microservices) into a deployable package that can run on different platforms.

The containerized environment provided as part of the cloud-native mobile network 111 includes nodes as units of computing hardware, such as a virtual machine or a physical machine in a database. The containerization allows insertion to a level of abstraction so that each node is viewed as a machine providing computing resources, such as a set of CPUs and RAM resources that can be utilized by applications running in this containerized environment.

In containerized environments, programs (such as applications, artifacts, components, services) running on a cluster are not limited to run on a specific node, and can be saved at arbitrary locations within the file system - rather than being tied to being executed and stored on a particular node. The computing resources, such as CPU and RAM resources of all nodes allocated to a cluster are managed together as part of the management of the cluster.

Programs in a containerized environment are deployed as containers that can be reallocated from one availability zone to another. For example, an application such as CNF-1 150a can be deployed as a container application on a containerized cluster 135a of a set of containerized clusters 135 at the different availability zones 131. The CNF-1 150a application can run and provide services to end users or other services/applications. In some implementations, multiple programs can be added into a single container, however some containers may be defined for the execution of a single process.

In some implementations, mobile network functions can be executed by combining network services and running the network functions in a containerized environment. The network functions can be distributed across the network 111 at various geographical locations where the availability zones 131 are hosted (e.g., at data centers at defined geo-locations spread around the world) for example, depending on where the services are needed. In the example shown in FIG. 1B, the availability zones 131a-131n of the cloud-native mobile network 111 include containerized clusters 135a-135n (135, in general), respectively, for executing applications. Examples of applications that are executed on the clusters 135 include various cloud-native functions (CNF) applications 150a, 150b, etc., or other applications/services. In some implementations, a cluster can include a set of nodes that together provide resources for deploying applications and/or services on the cluster. If nodes are added or removed from a cluster, the cluster can continue to function, for example, by redistributing the execution of the applications over the remaining nodes of the cluster.

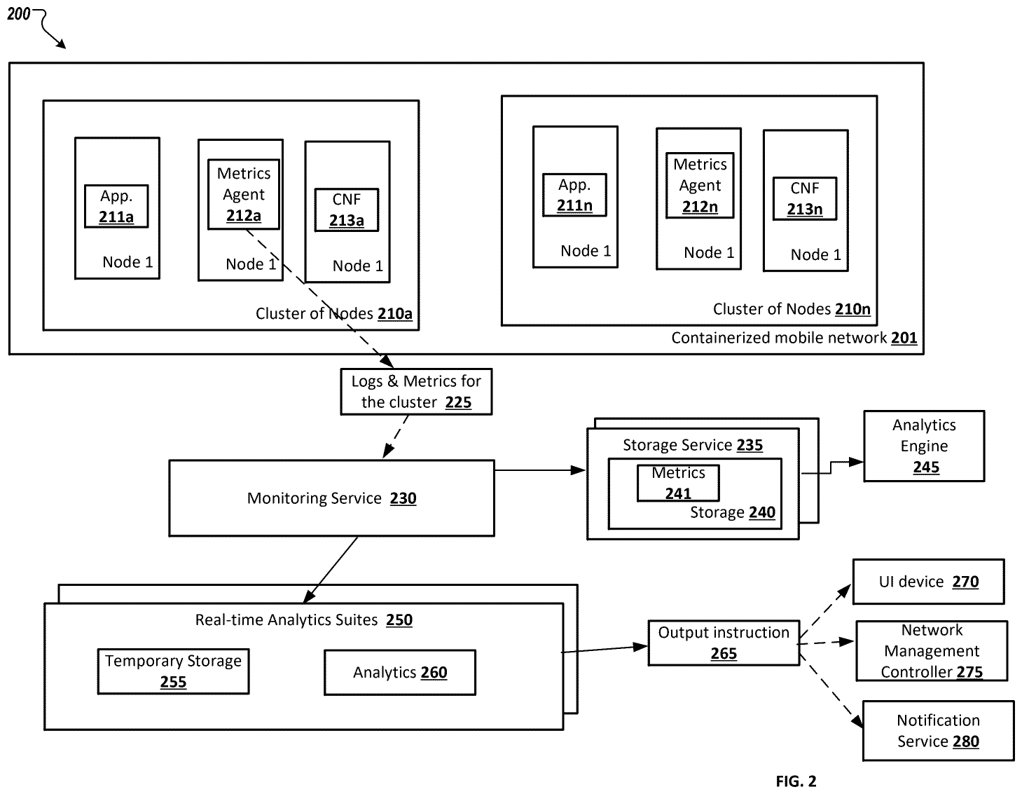

FIG. 2 is a block diagram of functional units of an example of a virtual network environment 200 that includes a cloud-native containerized mobile network 201.

In some implementations, the cloud-native containerized mobile network 201 can be substantially similar to the cloud-native mobile network 111 of FIG. 1B and can host applications, services, functions, or else at one or multiple data centers that can be distributed over one or multiple geo-locations. The cloud-native containerized mobile network 201 can be executed over one or more cloud platforms that can be provided by one or different cloud platform providers. The cloud-native containerized mobile network 201 can provide hardware and software resources to cloud-based applications (e.g., network components) running on nodes over clusters of the containerized mobile network 201. The cloud-native containerized mobile network 201 can be used to create, manage, and maintain 5G core components (units or subunits) needed for providing a mobile network that is functional and operational. In some implementations, the cloud-native containerized mobile network 201 may be configurable to add more instances of applications and services if network traffic increases, without additional hardware. In some implementations, the containerized mobile network 201 can be extended to add clusters associated with accounts (e.g., existing accounts defined for the network 201 or new accounts to be added).

In some implementations, the containerized mobile network 201 can provide clusters of nodes where instances of the 5G core components can be created and managed in a containerized setup, for example, by using KUBERNETES®, DOCKER®, or another container orchestration platform. The containerized mobile network 201 includes multiple clusters of nodes including cluster of nodes 210a and cluster of nodes 210n (clusters 210), where each of these clusters includes multiple nodes that can host applications, such as app 211a and app 211n, and network functions, such as CNF 213a and CNF 213n. The CNFs can be deployed on nodes of the cluster so that each CNF encapsulates physical and virtual network functions. In some implementations, a node on each cluster of the containerized mobile network 201 can host a metrics agent, such as metrics agent 212a and metrics agent 212n that can collect data that includes performance metrics and log data from the respective cluster. Such metrics and log data can be both related to CNFs running on each cluster and performance of the respective cluster according to the provided computing resources by nodes assigned to the respective cluster. The data collected by or compiled at the metrics agents can be provided as log and metrics data 225 for the cluster 210a to a monitoring service 230.

The monitoring service 230 can be configured to communicate with the clusters on the containerized mobile network 201 and obtain performance metrics and log data, for example, over regular intervals and/or as pushed from each cluster. In some implementations, whenever a new cluster of nodes is instantiated on the containerized mobile network 201, a metrics agent is instantiated on one of the cluster nodes, and the monitoring service 230 can be configured to communicate with that metrics agent. For example, the monitoring service 230 can be configured to receive notifications from metrics agents through polling, or the metrics agents can be configured to push obtained performance metrics and log data to the monitoring service 230. The monitoring service 230 can store the obtained data at a storage 240 provided by a storage service 235. In some implementations, obtained logs and metrics 225 from cluster of nodes 210 can be stored as metrics 241 on the storage 240, where when other metrics or log data is received by the monitoring service 230, that data can be further included in the metrics 241 on the storage 240. In some implementations, the storage service 235 can be a cloud service that can be provided from another environment and not part of the containerized mobile network 201. The storage service 235 can be used to consolidate data from the containerized mobile network 201 and the various clusters running on the network 201. In some cases, the storage service 235 can be used to store metrics data for other containerized mobile networks that can be configured to be monitored through the monitoring service 230 or through another service. In some implementations, the stored metrics 241 data can be used, and analytics can be performed at an analytics engine 245. The analytics can be performed to determine trends in the performance of the clusters on the containerized mobile network 201 and determine regularly occurring issues that can be remedied, for example, through modifying the resources provided for a cluster, through updating an application or function, through instantiating an instance of an application or function, or restarting an instance of an application or function. In some implementations, based on performing an evaluation over collected metrics data 241, a determination for instantiating one or more other instances of a given function, such as CNF 213 can be provided. Based on such determination, instructions for adjustments to the containerized mobile network 201 can be provided, for example, for processing by an orchestrator that can manage the lifecycle of instances on the network 201. In some implementations, by performing such evaluation and determining remedying actions, the performance of the mobile network 201 can be improved and network services can be provided more steadily and reliably.

In some implementations, when the monitoring service 230 obtains performance metrics and log data (e.g., the logs and metrics 225 of cluster of nodes 210), the obtained data can be automatically provided to a real-time analytics suite 250 for performing a real time evaluation of the current state of performance of the containerized mobile network 201. In some implementations, the performance metrics and log data can be stored at a temporary storage 255 and evaluated based on rules and conditions defined at the analytics 260 module. Based on performed evaluation of the current performance metrics and log data, a performance issue affecting at least one CNF on a cluster of the containerized mobile network 201. In response to identifying the performance issue, an operation for remedying the performance issue can be determined and output instructions 265 for remedying the performance issue by affecting the operations at the at least one CNF can be provided. Such instructions can be sent to a user interface device 270 so that the identified issue and available options to remedy the issue can be presented for visualization. In some implementations, the UI device 270 can be provided with dynamically updated status of the current state of one or more of the clusters of the containerized mobile network 210. In some cases, the output instructions 265 can be automatically sent to a network management controller 275 that can be configured to manage the lifecycle of processes and instances on the containerized mobile network 201 or can be communicatively coupled to an orchestrator responsible for the management of network. In some implementations, the output instructions 265 can be provided to a notification service 280, where the containerized mobile network 201 can be configured to receive notification about the performance of the clusters through the notification service 280.

In some implementations, in response to performing evaluation of the metrics and log data at the real-time analytics suite 250 or at the analytics engine 245, a notification to at least an external responder system connected to at least one of the set of clusters can be provided. The notification can include, for example, a message, alert, alarm, etc., that can be displayed or otherwise presented on a device associated with the external responder system. The notification can include identification of an action to be executed at an entity/functional module of the 5G O-RAN. For example, the actions can include a set of lifecycle operations to be executed for applications/functions running at one or more of the set of clusters. The set of lifecycle operations can include, for example, one or more of: restarting, updating, upgrading, or rebuilding of an application running on a cluster of the set of clusters.

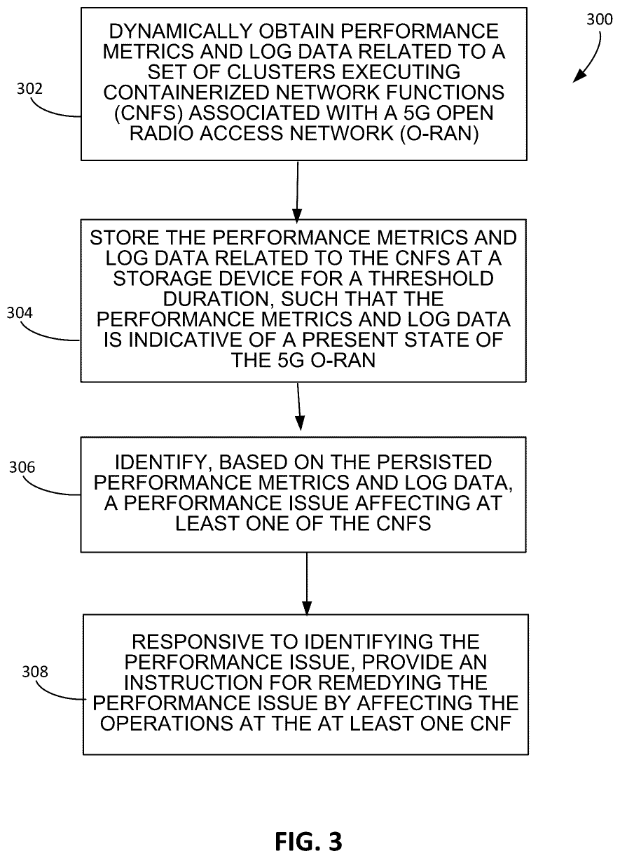

FIG. 3 is a flowchart of an example of a process 300 for providing instructions for remedying performance issues affecting operations of network functions in a containerized environment in accordance with monitored performance metrics. The network functions can be executed on a containerized mobile network, such as the cloud-native mobile network 111 of FIG. 1B. The operations of the process 300 can be executed outside the containerized mobile network based on obtained data from the running functions in accordance with implementations of the present disclosure (302). In some implementations, the process 300 can be executed at a monitoring service such as the monitoring service 230 of FIG. 2 or at an analytical tool for evaluating the performance of the containerized mobile network, such as the real-time analytics suite 250 of FIG. 2.

Operations of the process 300 include dynamically obtaining (302), at one or more computing devices, performance metrics and log data related to a set of clusters executing containerized network functions (CNFs) associated with a 5G open radio access network (O-RAN). The CNFs are executed on a distributed system. In some implementations, the set of clusters can be registered at a monitoring service, such as the monitoring service 230 of FIG. 2.

In some implementations, each cluster runs at least one CNF deployed on a node of a cluster of the set. For example, the set of clusters and the running CNFs can be as shown in relation to FIG. 2. In some implementations, each CNF can encapsulate physical and virtual network functions.

In some implementations, each clusters runs a performance agent (e.g., the metrics agent 212 of FIG. 2) that provides data that includes the performance metrics and the log data, both related to the set of CNFs and performance of the respective cluster according to the provided computing resources by nodes assigned to the respective cluster.

Operations of the process 300 include storing the performance metrics and log data related to the CNFs at a storage device for a threshold duration, such that the stored performance metrics and log data is indicative of a present state of the 5G O-RAN (304).

Operations of the process 300 include identifying, by the one more computing devices and based on the stored performance metrics and log data, a performance issue affecting at least one of the CNF (306).

In some implementations, the identification of the performance issue can be performed by receiving input based on an executed request for determining a current state of the performance of the containerized mobile network and the included one or more clusters of nodes. In some implementations, the identification of the performance issue can be performed as part of a real-time evaluation scenario and based on evaluating performance over a predefined time-period that is a short-run review. In some implementations, the identification of the performance issue can be performed as an offline process and over a long-run period for review, where identification of performance issues can be determined as recurring or regularly observed issues. In some implementations, an offline analysis can be performed over collected data to identify actions to be used for generating instructions to remedy performance issued as identified at the containerized mobile network.

Operations of the process 300 include providing an instruction for remedying the performance issue by affecting the operations at the at least one CNF responsive to identifying the performance issue (308).

Optionally, In some implementations, the process 300 can include operations including receiving information indicative of a creation of a new account at a new set of clusters, wherein the new set of clusters are instantiated at the 5G O-RAN; and automatically obtain new performance metrics and log data for the new account from a monitoring service to be stored at i) an analytics suite for temporary storage and ii) the storage device, wherein the new account is registered at a monitoring service so that the new set of clusters automatically provide the performance metrics and log data to the monitoring service.

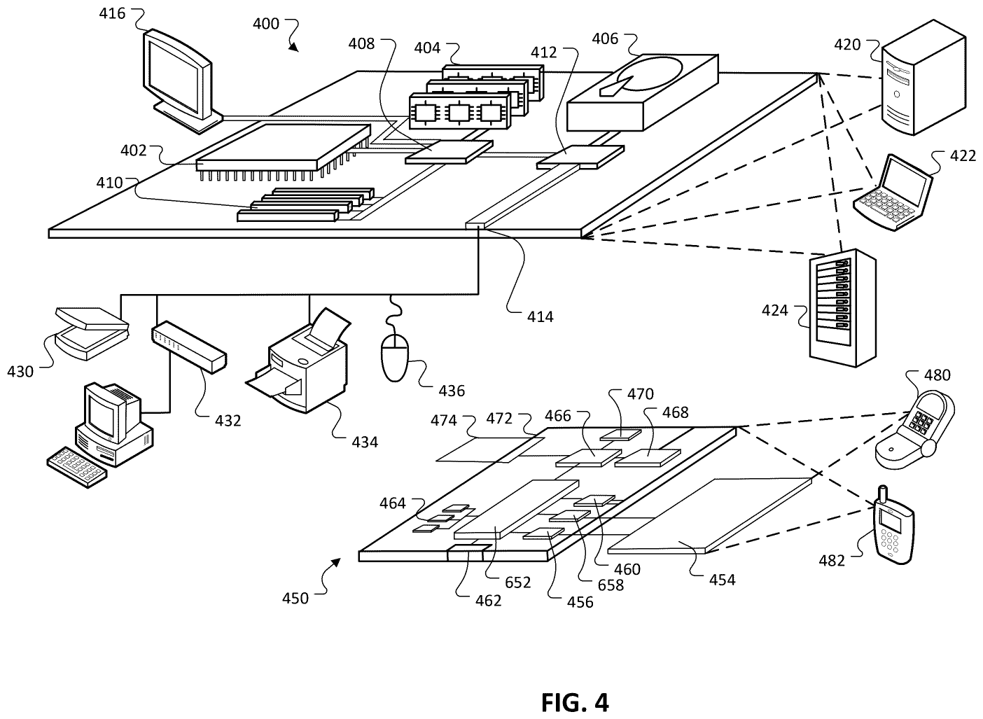

FIG. 4 shows an example of a computing device 400 and a mobile computing device 450 that are employed to execute implementations of the present disclosure. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 400 and/or the mobile computing device 450 can form at least a portion of the network environments (e.g., environment 100) described above. The computing device 400 and/or the mobile computing device 450 can also form at least a portion of the user-devices (e.g., user-device 144) described above. In some implementations, the network functions and/or network entities described above can be implemented using a cloud infrastructure including multiple computing devices 400 and/or mobile computing devices 450.

The computing device 400 includes a processor 402, a memory 404, a storage device 406, a high-speed interface 408, and a low-speed interface 412. In some implementations, the high-speed interface 408 connects to the memory 404 and multiple high-speed expansion ports 410. In some implementations, the low-speed interface 412 connects to a low-speed expansion port 414 and the storage device 404. Each of the processor 402, the memory 404, the storage device 406, the high-speed interface 408, the high-speed expansion ports 410, and the low-speed interface 412, are interconnected using various buses, and may be mounted on a common motherboard or in other manners as appropriate. The processor 402 can process instructions for execution within the computing device 400, including instructions stored in the memory 404 and/or on the storage device 406 to display graphical information for a graphical user-interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of a computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 402, perform one or more methods, such as those described above. The instructions can also be stored by one or more storage devices, such as computer-readable or machine-readable mediums, such as the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards. In the implementation, the low-speed interface 412 is coupled to the storage device 406 and the low-speed expansion port 414. The low-speed expansion port 414, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 414 through a network adapter. Such network input/output devices may include, for example, a switch or router.

The computing device 400 may be implemented in a number of different forms, as shown in the FIG. 4. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may contain one or more of the computing device 400 and the mobile computing device 450, and an entire system may be made up of multiple computing devices communicating with each other.

The mobile computing device 450 includes a processor 452; a memory 464; an input/output device, such as a display 454; a communication interface 466; and a transceiver 468; among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate. In some implementations, the mobile computing device 450 may include a camera device(s).

The processor 452 can execute instructions within the mobile computing device 450, including instructions stored in the memory 464. The processor 452 may be implemented as a chipset of chips that include separate and multiple analog and digital processors. For example, the processor 452 may be a Complex Instruction Set Computers (CISC) processor, a Reduced Instruction Set Computer (RISC) processor, or a Minimal Instruction Set Computer (MISC) processor. The processor 452 may provide, for example, for coordination of the other components of the mobile computing device 450, such as control of user-interfaces (UIs), applications run by the mobile computing device 450, and/or wireless communication by the mobile computing device 450.

The processor 452 may communicate with a user through a control interface 458 and a display interface 456 coupled to the display 454. The display 454 may be, for example, a Thin-Film-Transistor Liquid Crystal Display (TFT) display, an Organic Light Emitting Diode (OLED) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a Single in Line Memory Module (SIMM) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or non-volatile random-access memory (NVRAM), as discussed below. In some implementations, instructions are stored in an information carrier. The instructions, when executed by one or more processing devices, such as processor 452, perform one or more methods, such as those described above. The instructions can also be stored by one or more storage devices, such as one or more computer-readable or machine-readable mediums, such as the memory 464, the expansion memory 474, or memory on the processor 452. In some implementations, the instructions can be received in a propagated signal, such as, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 5G technologies. Such communication may occur, for example, through the transceiver 468 using a radio frequency. In addition, short-range communication, such as using a Bluetooth or Wi-Fi, may occur. In addition, a Global Positioning System (GPS) receiver module 470 may provide additional navigation-and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in FIG. 4. For example, it may be implemented in the user-device described with respect to FIG. 1. Other implementations may include a phone device 480, a personal digital assistant 482, and a tablet device (not shown). The mobile computing device 450 may also be implemented as a component of a smart-phone, AR device, or other similar mobile device.

The computing device 400 may be implemented in the network environment 100 described above with respect to FIGS. 1-5.

Computing device 400 and/or 450 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments.

What is claimed is:

1. A computer-implemented method comprising:
dynamically obtaining, at one or more computing devices, performance metrics and log data related to a set of clusters executing containerized network functions (CNFs) associated with a 5G open radio access network (O-RAN), the CNFs executing on a distributed system for orchestrating operations of containerized applications;
storing the performance metrics and log data at a storage device for a threshold duration, such that the performance metrics and log data is indicative of a present state of the 5G O-RAN;
identifying, by the one or more computing devices and based on the performance metrics and log data, a performance issue affecting at least one of the CNFs; and
responsive to identifying the performance issue, providing an instruction for remedying the performance issue by affecting the operations of at the at least one CNF.

2. The method of claim 1, wherein the distributed system includes multiple availability zones, each availability zone including a subset of the set of clusters, and wherein identifying the performance issue is based on a portion of the performance metrics and log data collected for a corresponding availability zone.

3. The method of claim 1, comprising:
registering the set of clusters at a monitoring service for providing data including the performance metrics and the log data.

4. The method of claim 1, wherein each cluster runs at least one CNF deployed on a node of the cluster, wherein each CNF encapsulates physical and virtual network functions associated with the 5G O-RAN.

5. The method of claim 4, wherein each clusters executes a performance agent to collect performance metrics and log data related to a CNF running on each cluster, wherein the performance metrics and the log data are usable to determine performance of the respective cluster.

6. The method of claim 1, comprising:
storing the data in a storage device for executing offline analysis and identifying actions to be used for generating the instruction.

7. The method of claim 1, comprising:
receiving information indicative of a creation of a new account at a new set of clusters, wherein the new set of clusters are instantiated at the 5G O-RAN; and
automatically obtaining new performance metrics and log data for the new account from a monitoring service to be stored at i) an analytics suite for temporary storage and ii) the storage device, wherein the new account is registered at a monitoring service so that the new set of clusters automatically provide the performance metrics and log data to the monitoring service.

8. The method of claim 1, wherein providing the instruction comprises:
providing a notification to at least an external responder system associated with at least one cluster of the set of clusters, wherein providing the notification comprises displaying the notification at a display device associated with the external responder system, the notification comprising a definition of an action to be executed at the 5G O-RAN, the action being at least one of a set of lifecycle operations to be executed for applications running at one or more of the set of clusters, the set of lifecycle operations comprising at least one of restarting, updating, upgrading, rebuilding of an application running on a cluster of the set of clusters.

9. A system comprising:
one or more processors; and
one or more computer-readable memories coupled to the one or more processors and having instructions stored thereon that are executable by the one or more processors to perform operations comprising:
dynamically obtaining, at one or more computing devices, performance metrics and log data related to a set of clusters executing containerized network functions (CNFs) associated with a 5G open radio access network (O-RAN), the CNFs executing on a distributed system for orchestrating operations of containerized applications;
storing the performance metrics and log data at a storage device for a threshold duration, such that the performance metrics and log data is indicative of a present state of the 5G O-RAN;
identifying, by the one or more computing devices and based on the performance metrics and log data, a performance issue affecting at least one of the CNFs; and
responsive to identifying the performance issue, providing an instruction for remedying the performance issue by affecting the operations of at the at least one CNF.

10. The system of claim 9, wherein the distributed system includes multiple availability zones, each availability zone including a subset of the set of clusters, and wherein identifying the performance issue is based on a portion of the performance metrics and log data collected for a corresponding availability zone.

11. The system of claim 9, wherein the one or more computer-readable memories have further instructions stored thereon that when executed by the one or more processors cause the one or more processors to perform operations comprising:
registering the set of clusters at a monitoring service for providing data including the performance metrics and the log data.

12. The system of claim 9, wherein each cluster runs at least one CNF deployed on a node of the cluster, wherein each CNF encapsulates physical and virtual network functions associated with the 5G O-RAN.

13. The system of claim 12, wherein each clusters executes a performance agent to collect performance metrics and log data related to a CNF running on each cluster, wherein the collected performance metrics and log data are usable to determine performance of the respective cluster.

14. The system of claim 9, wherein the one or more computer-readable memories have further instructions stored thereon that when executed by the one or more processors cause the one or more processors to perform operations comprising:
storing the data in a storage device for executing offline analysis and identifying actions to be used for generating the instruction.

15. The system of claim 9, wherein the one or more computer-readable memories have further instructions stored thereon that when executed by the one or more processors cause the one or more processors to perform operations comprising:
receiving information indicative of a creation of a new account at a new set of clusters, wherein the new set of clusters are instantiated at the 5G O-RAN; and
automatically obtaining new performance metrics and log data for the new account from a monitoring service to be stored at i) an analytics suite for temporary storage and ii) the storage device, wherein the new account is registered at a monitoring service so that the new set of clusters automatically provide the performance metrics and log data to the monitoring service.

16. A non-transitory computer-readable medium storing instructions that are executable by a processing device, and upon such execution cause the processing device to perform operations comprising:
dynamically obtaining, at one or more computing devices, performance metrics and log data related to a set of clusters executing containerized network functions (CNFs) associated with a 5G open radio access network (O-RAN), the CNFs executing on a distributed system for orchestrating operations of containerized applications;
storing the performance metrics and log data at a storage device for a threshold duration, such that the performance metrics and log data is indicative of a present state of the 5G O-RAN;
identifying, by the one or more computing devices and based on the performance metrics and log data, a performance issue affecting at least one of the CNFs; and
responsive to identifying the performance issue, providing an instruction for remedying the performance issue by affecting the operations of at the at least one CNF.

17. The non-transitory computer-readable medium of claim 16, wherein the distributed system includes multiple availability zones, each availability zone including a subset of the set of clusters, and wherein identifying the performance issue is based on a portion of the performance metrics and log data collected for a corresponding availability zone.

18. The non-transitory computer-readable medium of claim 16, further storing instructions that when executed by the processing device cause the processing device to perform operations comprising:
registering the set of clusters at a monitoring service for providing data including the performance metrics and the log data.

19. The non-transitory computer-readable medium of claim 16, wherein each cluster runs at least one CNF deployed on a node of the cluster, wherein each CNF encapsulates physical and virtual network functions associated with the 5G O-RAN.

20. The non-transitory computer-readable medium of claim 19, wherein each clusters executes a performance agent to collect performance metrics and log data related to a CNF running on each cluster, wherein the collected performance metrics and log data are usable to determine performance of the respective cluster.
